(19) United States
(12) Patent Application Publication
(10) Pub. No.: US 2024/0249113 A1
(43) Pub. Date: Jul. 25, 2024

(54) SYSTEMS AND METHODS FOR SEMANTIC PARSING WITH EXECUTION FOR ANSWERING QUESTIONS OF VARYING COMPLEXITY FROM UNSTRUCTURED TEXT

(71) Applicant: Salesforce, Inc., San Francisco, CA (US)

(72) Inventors: Ye LIU, Fremont, CA (US); Semih YAVUZ, Redwood City, CA (US); Rui MENG, San Francisco, CA (US); Yingbo ZHOU, Palo Alto, CA (US)

(21) Appl. No.: 18/335,044

(22) Filed: Jun. 14, 2023

Related U.S. Application Data
(60) Provisional application No. 63/480,622, filed on Jan. 19, 2023.

(51) Int. Cl. G06N 3/045; G06F 16/332; G06N 3/084

(52) U.S. Cl. CPC G06N 3/045; G06F 16/3329; G06N 3/084

(57) ABSTRACT

Embodiments described herein provide systems and methods for question answering using a hybrid question parser and executor model. The hybrid question parser and executor model includes a hybrid parser model and a hybrid executor model. The hybrid parser model includes a first neural network model, and generates a representation of an input question. The representation includes primitives and operations representing relationships among the primitives. The hybrid executor model generates an answer to the input question by executing the representation based on an input text document. The hybrid executor model includes an execution neural network model for executing the primitives of the representation, and an execution programming model for executing the operations of the representation.

### CROSS REFERENCE(S)

The instant application is a nonprovisional of and claims priority under 35 U.S.C. 119 to U.S. provisional application No. 63/480,622, filed Jan. 19, 2023, which is hereby expressly incorporated by reference herein in its entirety

### TECHNICAL FIELD

The embodiments relate generally to machine learning systems for question answering, and more specifically to semantic parsing with execution for answering questions of varying complexity from unstructured text.

### BACKGROUND

Machine learning systems have been widely used in question answering (QA). For example, question answering (QA) systems are developed to help users to interact with massive data using queries in natural language. Answer directly and semantic parsing are two mainstream categories to solve question answer tasks. A semantic parser aims at converting natural language questions to intermediate logical forms, followed by an executable engine to generate predicted answers by executing the intermediate logical forms. However, using semantic parsers in the textual domain for textual question answering (“Textual QA”) systems is challenging. One challenge is that it's hard to define the logical form for the textual questions. Another challenge is that it is more difficult to design the execution on plain unstructured text compared to structured data.

Therefore, there is a need for developing improved question answer systems for answering questions of varying complexity from unstructured text.

### BRIEF DESCRIPTION OF THE DRAWINGS

FIG. 1 is a simplified diagram illustrating a computer device implementing a hybrid question parser and executor (HPE) framework (also referred to as a parsing with execution (TSP) framework) for textual QA, according to some embodiments.

FIG. 2 is a simplified block diagram of a networked system suitable for implementing the HPE framework, according to some embodiments.

FIG. 3 is a simplified diagram illustrating an example neural network structure implementing one or more neural network models of the HPE module 130 described in FIG. 1, according to some embodiments.

FIG. 4 is a simplified block diagram of an example HPE framework, according to some embodiments.

FIG. 5 illustrates example grammars and rules for an H-Expression used in the HPE framework, according to some embodiments.

FIG. 6 illustrates an example parsing process of the HPE framework, according to some embodiments.

FIG. 7 illustrates an example tree structure of an H-Expression used in the HPE framework, according to some embodiments.

FIG. 8 illustrates an example execution process of the HPE framework, according to some embodiments.

FIG. 9 is an example logic flow diagram illustrating a method of performing question answering using the HPE framework, according to some embodiments described herein.

FIGS. 10-18 illustrate exemplary performance results of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

In view of the need for improved question answering systems, embodiments described herein provide an HPE framework for answering complex questions over text. The HPE framework combines the strengths of neural network approaches and symbolic approaches. In various embodiments, an input question may be parsed into H-Expressions, followed by the hybrid execution to get the final answer.

Embodiments described herein provide a number of benefits. For example, the HPE framework has a strong performance on various datasets under supervised, few-shot, and zero-shot settings. For another example, the HPE framework has a strong interpretability, because its transparency of the underlying reasoning process facilitates understanding and possibly fixing its errors. Yet for another example, the HPE framework is flexible, and may be extended to solve knowledgebase QA or table QA by replacing its execution neural network model (e.g., a single-hop reader) with other suitable neural network models (e.g., knowledge based neural network model or database table based neural network models).

### Computer and Network Environment

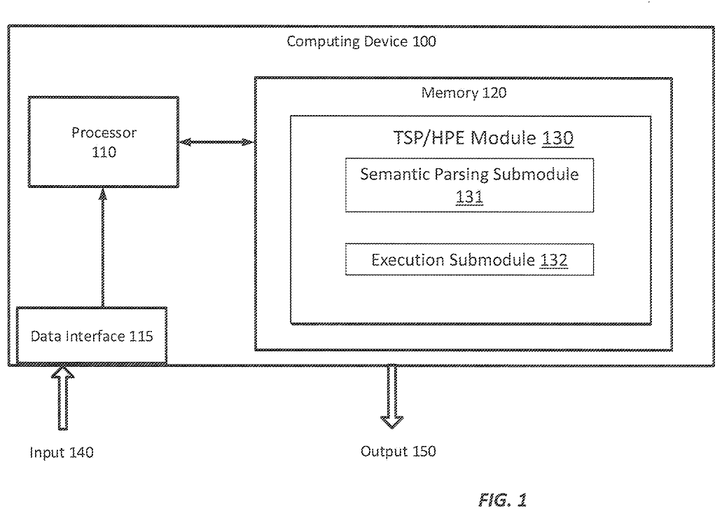

FIG. 1 is a simplified diagram illustrating a computing device implementing the HPE framework described throughout the specification, according to one embodiment described herein. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities.

In some examples, memory 120 may include non-transitory, tangible, machine readable media that includes executable code that when run by one or more processors (e.g., processor 110) may cause the one or more processors to perform the methods described in further detail herein. For example, as shown, memory 120 includes instructions for HPE module 130 that may be used to implement and/or emulate the systems and models, and/or to implement any of the methods described further herein. An HPE module 130 may receive input 140 such as input documents and input questions via the data interface 115 and generate an output 150, which may be an answer to the questions based on the documents.

The data interface 115 may comprise a communication interface, a user interface (such as a voice input interface, a graphical user interface, and/or the like). For example, the computing device 100 may receive the input 140 (such as a training dataset) from a networked database via a communication interface. Or the computing device 100 may receive the input 140, such as an articulated question, from a user via the user interface.

In some embodiments, the HPE module 130 is configured to generate an answer to a question based on the text. The HPE module 130 may further include a sematic parsing submodule 131 and an execution question generation submodule 132, which are all further described below. In one embodiment, the HPE module 130 and its submodules 131-132 may be implemented by hardware, software and/or a combination thereof.

Some examples of computing devices, such as computing device 100 may include non-transitory, tangible, machine readable media that include executable code that when run by one or more processors (e.g., processor 110) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

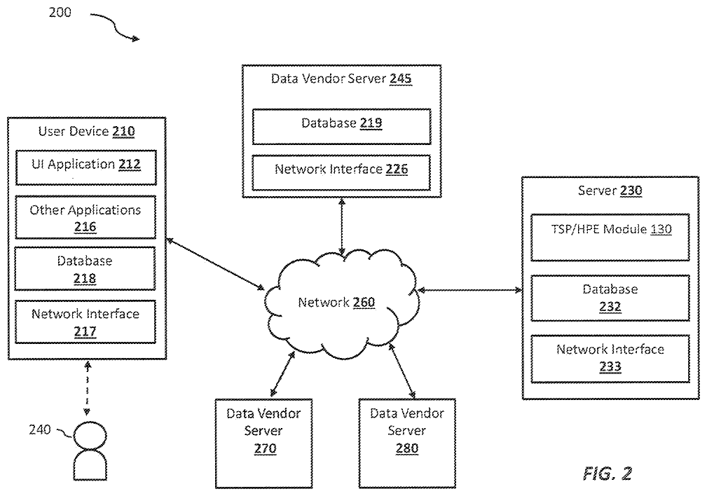

FIG. 2 is a simplified block diagram of a networked system suitable for implementing the HPE framework in embodiments described herein. In one embodiment, block diagram 200 shows a system including the user device 210 which may be operated by user 240, data vendor servers 245, 270 and 280, server 230, and other forms of devices, servers, and/or software components that operate to perform various methodologies in accordance with the described embodiments. Exemplary devices and servers may include device, stand-alone, and enterprise-class servers which may be similar to the computing device 100 described in FIG. 1, operating an OS such as a MICROSOFT® OS, a UNIX® OS, a LINUX® OS, or other suitable device and/or server-based OS. It can be appreciated that the devices and/or servers illustrated in FIG. 2 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 210, data vendor servers 245, 270 and 280, and the server 230 may communicate with each other over a network 260. User device 210 may be utilized by a user 240 (e.g., a driver, a system admin, etc.) to access the various features available for user device 210, which may include processes and/or applications associated with the server 230 to receive an output data anomaly report.

User device 210, data vendor server 245, and the server 230 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

User device 210 may be implemented as a communication device that may utilize appropriate hardware and software configured for wired and/or wireless communication with data vendor server 245 and/or the server 230. For example, in one embodiment, user device 210 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 210 of FIG. 2 contains a user interface (UI) application 212, and/or other applications 216, which may correspond to executable processes, procedures, and/or applications with associated hardware. For example, the user device 210 may receive a message indicating an answer to a visual question from the server 230 and display the message via the UI application 212. In other embodiments, user device 210 may include additional or different modules having specialized hardware and/or software as required.

In various embodiments, user device 210 includes other applications 216 as may be desired in particular embodiments to provide features to user device 210. For example, other applications 216 may include security applications for implementing client-side security features, programmatic client applications for interfacing with appropriate application programming interfaces (APIs) over network 260, or other types of applications. Other applications 216 may also include communication applications, such as email, texting, voice, social networking, and IM applications that allow a user to send and receive emails, calls, texts, and other notifications through network 260. For example, the other application 216 may be an email or instant messaging application that receives a prediction result message from the server 230. Other applications 216 may include device interfaces and other display modules that may receive input and/or output information. For example, other applications 216 may contain software programs for asset management, executable by a processor, including a graphical user interface (GUI) configured to provide an interface to the user 240 to view the answer.

User device 210 may further include database 218 stored in a transitory and/or non-transitory memory of user device 210, which may store various applications and data and be utilized during execution of various modules of user device 210. Database 218 may store user profile relating to the user 240, predictions previously viewed or saved by the user 240, historical data received from the server 230, and/or the like. In some embodiments, database 218 may be local to user device 210. However, in other embodiments, database 218 may be external to user device 210 and accessible by user device 210, including cloud storage systems and/or databases that are accessible over network 260.

User device 210 includes at least one network interface component 219 adapted to communicate with data vendor server 245 and/or the server 230. In various embodiments, network interface component 219 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 245 may correspond to a server that hosts one or more of the databases 203a-n (or collectively referred to as 203) to provide training datasets to the server 230. The database 203 may be implemented by one or more relational database, distributed databases, cloud databases, and/or the like.

The data vendor server 245 includes at least one network interface component 226 adapted to communicate with user device 210 and/or the server 230. In various embodiments, network interface component 226 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 245 may send asset information from the database 203, via the network interface 226, to the server 230.

The server 230 may be housed with the HPE module 130 and its submodules described in FIG. 1. In some implementations, module 130 may receive data from database 219 at the data vendor server 245 via the network 260 to generate an answer to a visual question. The generated answer may also be sent to the user device 210 for review by the user 240 via the network 260.

The database 232 may be stored in a transitory and/or non-transitory memory of the server 230. In one implementation, the database 232 may store data obtained from the data vendor server 245. In one implementation, the database 232 may store parameters of the HPE model 130. In one implementation, the database 232 may store previously generated answers, and the corresponding input feature vectors.

In some embodiments, database 232 may be local to the server 230. However, in other embodiments, database 232 may be external to the server 230 and accessible by the server 230, including cloud storage systems and/or databases that are accessible over network 260.

The server 230 includes at least one network interface component 233 adapted to communicate with user device 210 and/or data vendor servers 245, 270 or 280 over network 260. In various embodiments, network interface component 233 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 260 may be implemented as a single network or a combination of multiple networks. For example, in various embodiments, network 260 may include the Internet or one or more intranets, landline networks, wireless networks, and/or other appropriate types of networks. Thus, network 260 may correspond to small scale communication networks, such as a private or local area network, or a larger scale network, such as a wide area network or the Internet, accessible by the various components of system 200.

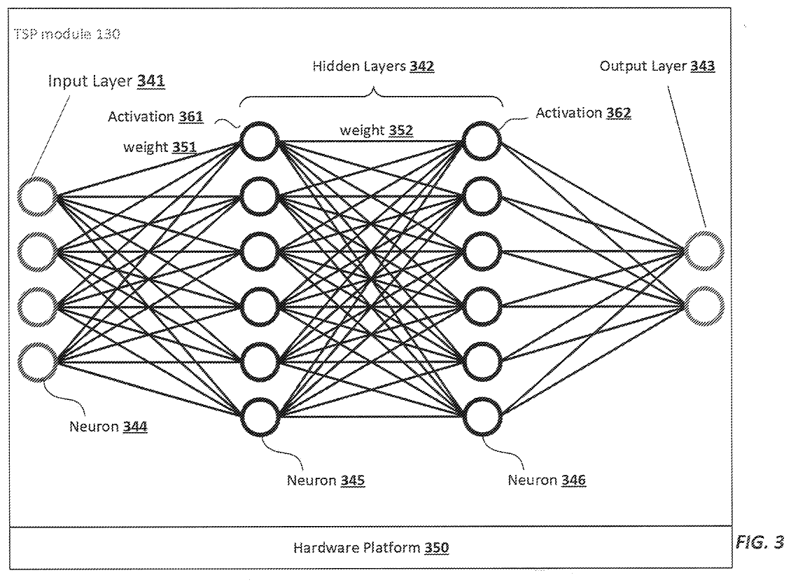

FIG. 3 is a simplified diagram illustrating the neural network structure implementing the HPE module 130 described in FIG. 1, according to one embodiment described herein. In one embodiment, the HPE module 130 and/or one or more of its submodules 131-132 may be implemented via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer receives the input data (e.g., an input question). The number of nodes (neurons) in the input layer 341 may be determined by the dimensionality of the input data (e.g., the length of a vector of the input question). Each node in the input layer represents a feature or attribute of the input.

The hidden layers 342 are intermediate layers between the input and output layers of a neural network. It is noted that two hidden layers 342 are shown in FIG. 3 for illustrative purpose only, and any number of hidden layers may be utilized in a neural network structure. Hidden layers 342 may extract and transform the input data through a series of weighted computations and activation functions.

For example, as discussed in FIG. 1, the HPE module 130 receives an input 140 of a question, and its semantic parsing submodule generates an output of a representation corresponding to the input question. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the HPE module 130 and/or one or more of its submodules 131-132 may comprise the transformative neural network structure of layers of neurons, and weights and activation functions describing the non-linear transformation at each neuron. Such a neural network structure is often implemented on one or more hardware processors 110, such as a graphics processing unit (GPU). An example neural network may be a T5 model, a generative encoder-decoder model (e.g., FiD), and/or the like.

In one embodiment, the HPE module 130 and its submodules 131 and 132 may be implemented by hardware, software and/or a combination thereof. For example, the HPE module 130 and its submodules 131 may comprise a specific neural network structure implemented and run on various hardware platforms 350, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware platform 350 used to implement the neural network structure is specifically configured depends on factors such as the complexity of the neural network, the scale of the tasks (e.g., training time, input data scale, size of training dataset, etc.), and the desired performance.

In one embodiment, the neural network based HPE module 130 and one or more of its submodules 131-132 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as input questions and paragraphs are fed into the neural network. The data flows through the network's layers 341, 342, with each layer performing computations based on its weights, biases, and activation functions until the output layer 343 produces the network's output 150.

The output generated by the output layer 343 is compared to the expected output (e.g., a “ground-truth” such as the corresponding correct answer for an input question) from the training data, to compute a loss function that measures the discrepancy between the predicted output and the expected output. For example, the loss function may be cross entropy, MMSE, any other suitable loss functions, or a combination thereof. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as performing question answering tasks.

Therefore, the training process transforms the neural network into an “updated” trained neural network with updated parameters such as weights, activation functions, and biases. The trained neural network thus improves neural network technology in question answering systems.

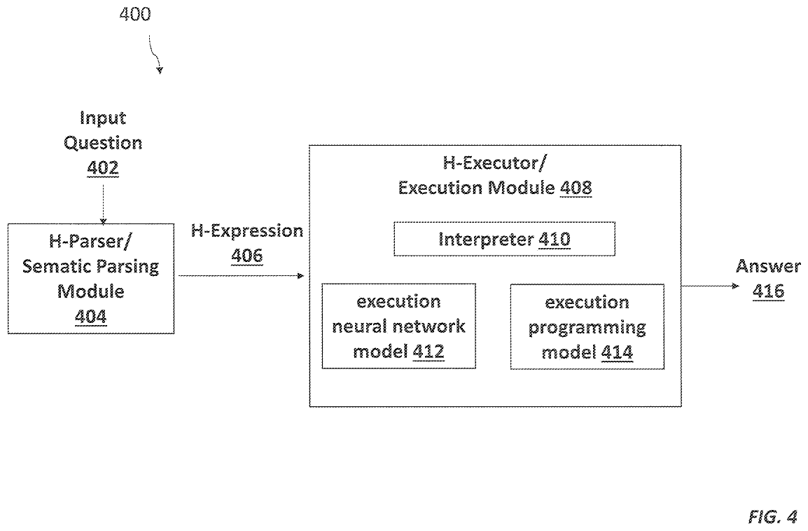

FIG. 4 is a simplified block diagram illustrating a HPE framework, according to one embodiment described herein. Conventionally, end-to-end neural models that transductively learn to map questions to their answers have been the dominating paradigm for textual question answering owing to their flexibility and solid performance. However, they often suffer from a lack of interpretability and generalizability. Symbolic reasoning, on the other hand, relies on producing intermediate explicit representations such as logical forms or programs, which can then be execute against a structured knowledge base (e.g., relational database, knowledge graph, etc.) to answer questions. These methods naturally offer better interpretability and precision thanks to the intermediate symbolic representations and their deterministic executions. However, they might be limited in expressing a broad range of questions in the wild depending on the semantic coverage of the underlying symbolic language and grammar employed. Neural Module Networks were proposed to combine neural and symbolic modality together. However, they require a symbolic language and a corresponding model that only covers limited scenarios in the specific task or domain. To apply this approach on new tasks or domains, new languages and neural modules have to be introduced. In chain-of-thought prompting works on large language model, complex questions may be solved by iteratively decomposing the unsolved question into simpler sub-questions that can be solved.

As shown in the examples of FIGS. 4-18 and explained in detail below, the HPE framework for textual question answering combines neural and symbolic reasoning, and is aimed at providing a generalizable framework that use a high-coverage symbolic expression and a flexible neural network that can be versatilely used in various scenarios. By using decomposition, the HPE framework makes the model generalizable to complex questions.

The HPE framework have advantages over various considerations, including for example, architecture, generalizability, and interpretability. For example, the HPE framework has an architecture that combines the advantages of both symbolic and neural reasoning paradigms by parsing questions into hybrid intermediate expressions that can be iteratively executed against the text to produce the final answer. Extensive experiments show that the HPE framework achieves state-of-the-art performance. For further example, the HPE framework achieves improved generalizability. Generally, end-to-end neural approaches are data hungry and may significantly suffer from poor generalization to unseen data, especially in limited resource scenarios. The HPE framework, on the other hand, naturally splits the reasoning process into H-Parser and H-executor, through which it may disentangle learning to parse complex questions structurally from learning to resolve simple questions therein. The few-shot experiments show that even with less training data, the HPE framework achieves better generalizability with unseen domains. For yet another example, the HPE framework provides improved interpretability. The execution process of the HPE framework is the same as its reasoning process, and as such, transparency of the approach facilitates spotting and fixing erroneous cases.

Referring to FIG. 4, an example HPE framework 400 is illustrated. The HPE framework 400 may perform a question-answer task in two main stages: the semantic parsing stage and the execution stage. At the semantic parsing stage, a semantic parsing module 404 (e.g., an H-Parser 404) may receive an input question 402, and generate a logical form 406 (e.g., an H-Expression 406) representing the input question 402. The H-Expression 406 may include primitives (e.g., single-hop questions) and operations (e.g., defining the relationships among the primitives). At the execution stage, an execution module 408 (e.g., an H-Executor 408) may execute the logical form (e.g., H-Expression 406) to generate an answer 416. For example, the H-Executor 408 may include an interpreter 410 to generate a tree structure representation from the H-Expression 406, where the primitives are tree nodes of the tree structure. An execution neural network model 412 (e.g., a single-hop Reader network) may be used to execute the primitives of the representation, and an execution programming model 414 (e.g., including deterministic rules) for executing the operations of the representation.

In the description below, textual question answering is formulated as the task of answering a question q given the textual evidence provided by passage set P. Assume access to a dataset of tuples {(qᵢaᵢPᵢ)|i=1 . . . n}, where aᵢ is a text string that defines the correct answer to question qᵢ. In conventional question answering systems, this tuple is often taken as input and the predicted answer is generated directly using this tuple.

The HPE framework 400 casts this question answering task as question parsing with hybrid execution. Given a question qᵢ, a question parser 404 is tasked to generate the corresponding H-Expression lᵢ 406. The generated H-Expression lᵢ 406 and the supporting passage set Pᵢ are given to the execution model 408 to generate the predicted answer 416.

Referring to FIGS. 4, 5, and 6, at the semantic parsing stage, H-Expression 406 (a hybrid expression consisting of primitives and operations) may be generated, which may serve as an intermediate representation connecting H-Parser 404 and H-Executor 408.

As shown in the example of FIG. 4, H-Parser 404 (e.g., a Seq2Seq model) may take the input question 402 as the input, and output an H-Expression 406 as an explicit representation of the input question 402. At the execution stage, H-executor 4-8 first compiles the H-Expression 406 into a tree structure, e.g., by symbolic rules. Then H-executor 408 uses a neural network model (e.g., a single-hop Reader) for the leaf nodes of the tree structure to perform simple question answering, and executes the symbolic operations of the tree structure based on those answers in a bottom-up manner to get the final prediction answer 416.

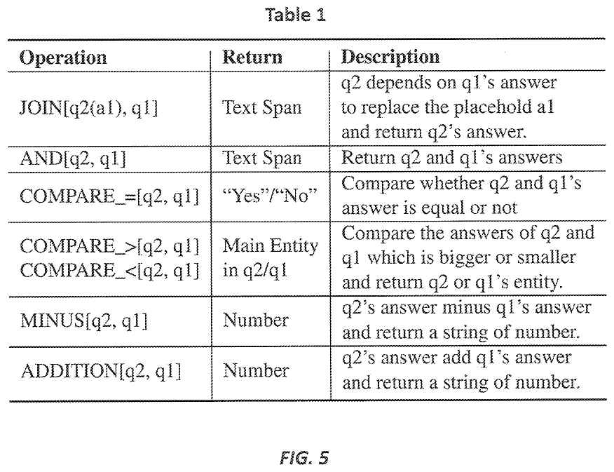

Referring to FIG. 5, the grammars and the rules of the H-Expression are described. As shown in Table 1 of FIG. 5, the H-Expression has its corresponding grammars and rules. The H-Expression provides a simple explicit representation of original complex questions, and in some examples may only contain primitives and operations. For example, a primitive of the H-Expression includes a single-hop question, which is the atomic element consisting of the complex question. For further example, an operation of the H-Expression may be used to represent the relation between primitives.

As shown in the example Table 1, H-Expression may include various types of operations, including e.g., JOIN, AND, COMPARE_=, COMPARE_>, COMPARE_<, MINUS and ADDITION. Each operation is a binary function that takes two primitives q2 and q1 as input, written as OP [q2, q1], where OP∈{JOIN, AND, COMPARE_=, COMPARE_>, COMPARE_<, MINUS and ADDITION}, where q1, q2 are format-free single-hop question. In the execution step, q1 will be executed first, then q2. Those operations can be combined into more complex H-Expression. For example, JOIN (q3, JOIN (q2, q1)) or JOIN (q3, AND (q2, q1)). For a single-hop question, its H-Expression is itself.

Operation definitions including returns and descriptions are also provided in Table 1, and the operations may be executed in the H-executor based on the operation definitions. More specifically, the JOIN operation is used for linear-chain type reasoning. q1 is the complete question that can be answered directly, and q2 is an incomplete question with a placeholder (a1) inside. In the execution step, this JOIN operation will be executed in a serial way, q2 will be executed first and the answer of q2 will be used to replace the placeholder in the q1. AND operation is used for intersection reasoning, which will return the intersection of the answer of q2 and q1. COMPARE= is used to determine if the answers of q2 and q1 are equal. The return value should be “Yes” or “No”. COMPARE_< and COMPARE_> operations will select the question entity corresponding to the smaller or the bigger answer of q2 and q1. MINUS and ADDITION operations are for subtractions and additions that involve the answers of q2 and q1.

As shown in FIG. 4, an H-Parser 404 may be used to generate the H-Expression 406, according to the defined grammars and rules. Conventionally, the semantic parsing process in knowledge base and database usually needs to interact with the background context to match natural questions to logical forms with the specified schema, which is a necessary condition to execute in knowledge base or table. However, in textual question answering, the question parsing process is context-independent, because it is desirable that the meaning of the input question and the H-Expression are equivalent without any additional information from the context.

In various embodiments, H-Parser 404 may be implemented using a neural network model, e.g., a seq-to-seq model, that takes a natural question q as input and generates the H-Expression 1 as the output. In an example, a T5 model (Raffel et al., 2020) may be used as the basis of the question parser H-Parser 404, as it demonstrates strong performance on various text generation tasks. In an example, the neural network model of the H-Parser 404 is trained by teacher forcing—the target H-Expression is generated token by token, and is optimized using cross-entropy loss. In some embodiments, during inference, beam search may be used to decode the top-k target H-Expression in an auto-regressive manner.

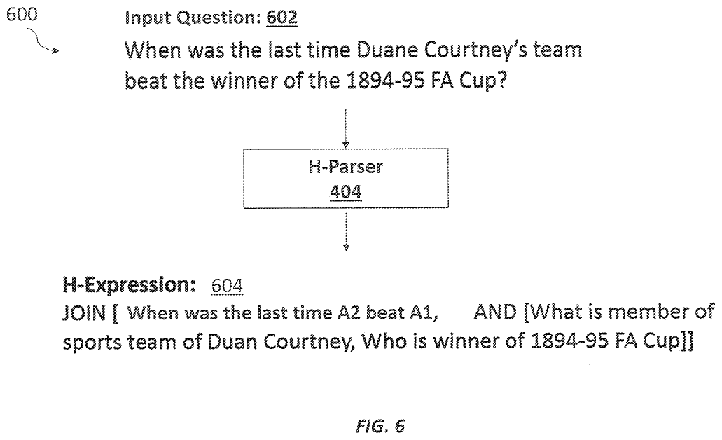

Referring FIG. 6, an example of a sematic parsing process 600 for a complex input question is illustrated. During the semantic parsing process 600, a complex question 602 (e.g., “When was the last time Duane Courtney's team beat the winner of the 1894-95 FA cup?”) is received by the H-Parser 404. The H-Parser 404 performs the semantic parsing, and generates a logical form, denoted as H-Expression 604, e.g., in the form of “JOIN [When was the last time A2 beat A1, AND [What is member of sports team of Duane Courtney, Who is winner of 1894-95 FA Cup]].” The example logical form H-Expression 604 is an H-Expression JOIN(q3, AND (q2, q1)), where q1, q2, and q3 are format-free single-hop questions, respectively, “What is member of sports team of Duane Courtney,” “Who is winner of 1894-95 FA Cup” and “When was the last time #2 beat #1.”

Referring to FIGS. 4, 7, and 8, at the execution stage of the HPE framework 400, an execution module 414 (e.g., an H-Executor 414) may execute the logical form (e.g., H-Expression 406) to generate an answer 416. Unlike the execution in database and knowledge base, which is fully program-based, the execution performed by H-Executor 414 has both a neural component and a symbolic component.

Referring back to FIG. 4, an interpreter 410 of the H-Executor 408 is used to generate a binary tree structure. As discussed above, H-Expression 406 has a nested structure, and the linear sequence cannot represent it well. As such, the H-Executor 408 first use an interpreter 410 to interpret the linear H-Expression 406 into a binary tree structure, where primitives are leaf nodes and operations are non-leaf nodes of the tree. Specifically, all primitives may be executed by the execution neural network model 412, and the non-leaf nodes may be executed by the execution programming model 414 (e.g., including deterministic symbolic rules) to generate new primitives or answers.

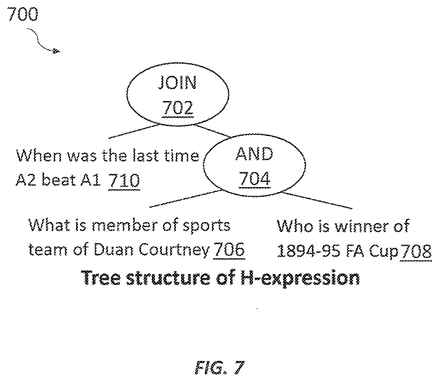

Referring to FIG. 7, an example binary tree structure 700 provided by an interpreter 410 for an H-Expression (e.g., H-Expression 604 of FIG. 6) is illustrated. The binary tree structure 700 includes leaf nodes 706, 708, and 710 for primitives of the H-Expression, and non-leaf nodes 702 and 704 for operations of the H-Expression.

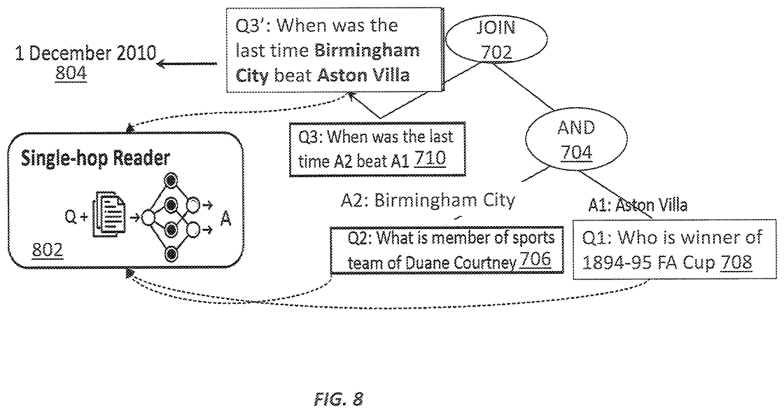

Referring to FIG. 8, an example execution process by H-Executor 408 based on the binary tree structure 700 is illustrated. The interpreter 410 may traverse from the rightmost leaf node 708 (corresponding to the right most primitive of the H-Expression), followed by its parent node and the left branch recursively, which is similar to in-order traversal with opposite leaf order. As shown in the example of FIG. 8, the leaf node 708 (corresponding to primitive Q1 “who is winner of 1894-95 FA Cup”) is the first primitive to be executed. Specifically, an execution neural network model 412 (e.g., using a single-hop reader 802) is used to answer this question of leaf node 708, which provides the answer “Aston Villa.”

Then non-leaf node 704 (corresponding to operation AND) is visited, which is executed by the execution programming model 414 to store A1 as “Aston Villa.” Next, the left leave node 706 (corresponding to primitive Q2 “what is member of sports team of Duane Courtney”) is visited. The execution neural network model 412 (e.g., using a single-hop reader 802) is used to answer this question Q2, and provides the answer “Birmingham City.” Then non-leaf node 704 (corresponding to operation AND) is visited, which is executed by the execution programming model 414 to stores this answer A2. Next the parent non-leaf node 702 (corresponding to JOIN operation) is visited, which is executed by the execution programming model 414 to replaces the place hold A1 and A2 in leaf node 710 (corresponding to Q3 “When was the last time A2 beat A1”) with the stored answers, and produce a new primitive Q3′ (“When was the last time Birmingham City beat Aston Villa”). This new primitive Q3′ is answered by the execution neural network model 412 (using single-hop reader 802) to generate the final answer 804 (“1 December 2010”).

In various embodiments, the execution neural network model 412 (e.g., a single-hop reader 802) is trained before the inference process for performing the question answering task. In an example, a FiD (Izacard and Grave, 2020) is used as the single-hop reader network, which is a generative encoder-decoder model. Each supporting passage is concatenated with the input question, and processed independently from other passages by the encoder. The decoder takes attention over the concatenation of all resulting representations from the encoder. To distinguish different components, special tokens including e.g., “question:,” “title:,” and “context:” may be added before the question, title and text of each passage respectively. Note that the reader network is detachable and may be replaced by any suitable reader model (e.g., a generative reader model or an extractive reader model).

In some embodiments, the HPE framework is provided based on an assumption that the single-hop question is much easier to answer, and it's feasible to have a global single-hop reader. A global single-hop reader may be adapted to any unseen dataset in a domain (e.g., a Wikipedia domain). To achieve a single-hop global reader, large-scale QA pairs from Probably-Asked Questions/PAQ (Lewis et al., 2021) are leveraged. To reduce the training computational cost, the neural network model is first pre-trained with a few passages to get a reasonable checkpoint, and then is finetuned using all supporting passages. In an example, the Seq2Seq model T5-large is first trained in the reading comprehension setting (with one positive passage) using PAQ data. Then the trained T5-large from PAQ is used to initialize the FiD model, and the FiD model further trained using training set of TriviaQA (Joshi et al., 2017), SQuAD (Rajpurkar et al., 2016), BoolQ (Clark et al., 2019) in a multiple passage setting (with one positive passage and nineteen negative passages). A global single-hop reader may be zero-shot used to unseen questions and also boost the performance of fine-tune setting as the pre-training weights.

### Example Workflows

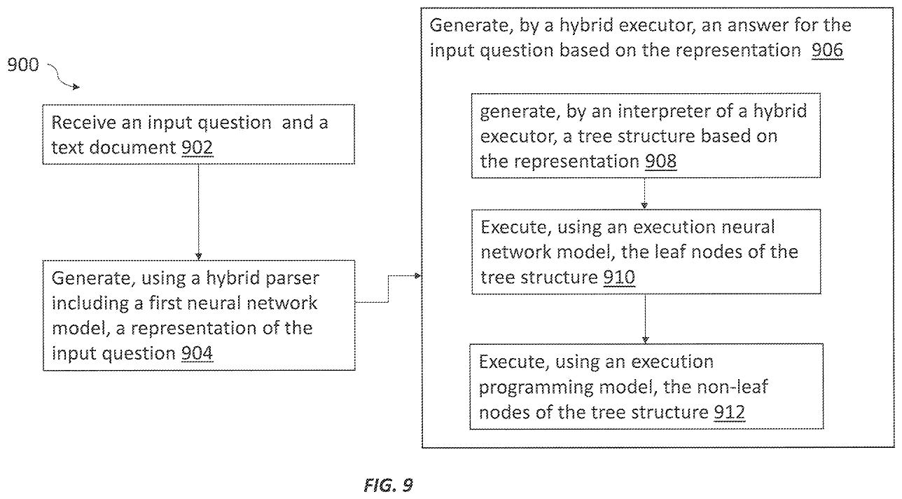

FIG. 9 is an example logic flow diagram illustrating a method 900 of performing question answering based on the HPE framework shown in FIGS. 1-8, according to some embodiments described herein. One or more of the processes of method 900 may be implemented, at least in part, in the form of executable code stored on non-transitory, tangible, machine-readable media that when run by one or more processors may cause the one or more processors to perform one or more of the processes. In some embodiments, method 900 corresponds to the operation of the HPE module 130 that performs question answering tasks.

As illustrated, the method 900 includes a number of enumerated steps, but aspects of the method 900 may include additional steps before, after, and in between the enumerated steps. In some aspects, one or more of the enumerated steps may be omitted or performed in a different order.

At step 902, an input question and a text document are received, e.g., via a data interface. At step 904, a hybrid parser is used to generate a representation of the input question. The representation includes primitives and operations representing relationships among the primitives. In the example of FIG. 4, the hybrid parser 404 (H-Parser) of the HPE framework 400 may include a neural network model, and may generate a representation (e.g., H-Expression 406) for the input question 402, which may include primitives (e.g., single-hop questions) and operations representing relationships among the primitives.

At step 906, a hybrid executor generates an answer for the input question based on the representation. In the example of FIG. 4, the hybrid executor 408 (H-Executor) of the HPE framework 400 receives the H-Expression 406, and generates an answer 416 based on the representation (H-Expression 406). Step 906 includes steps 908, 910, and 912. At step 908, an interpreter (e.g., Interpreter 410 of FIG. 4) is used to generate a tree structure based on the representation. At step 910, an execution neural network model (e.g., execution neural network model 412) may execute the leaf nodes of the tree structure to generate answers for the simpler questions in the leaf nodes. At step 912, an execution programming model (e.g., execution programming model 414) is used to execute the non-leaf nodes (operations) of the tree structure, together with the answers for the leaf nodes.

### Example Results

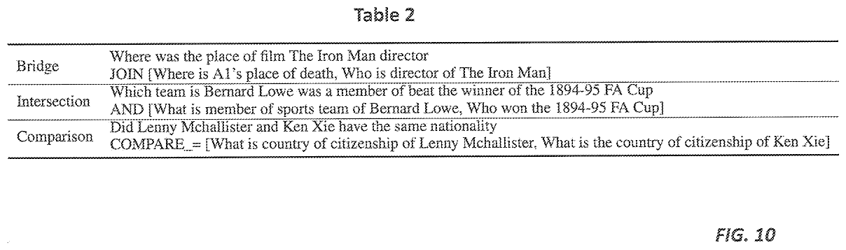

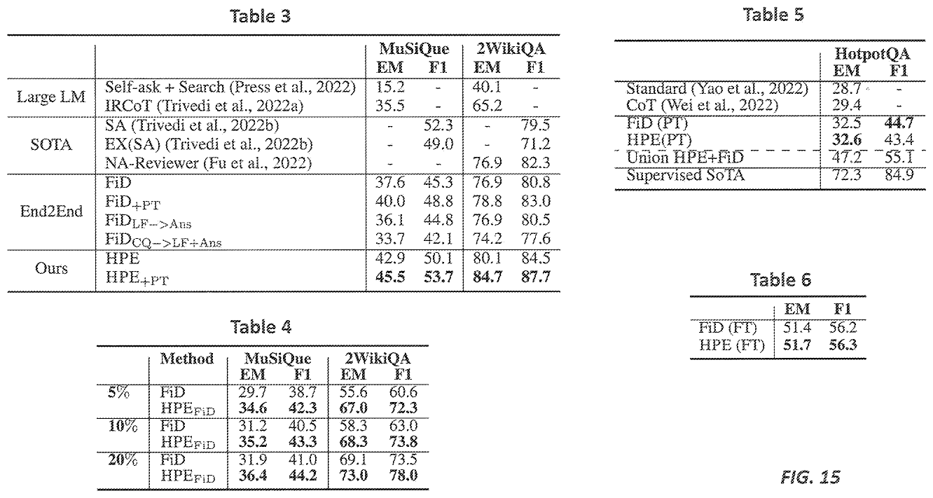

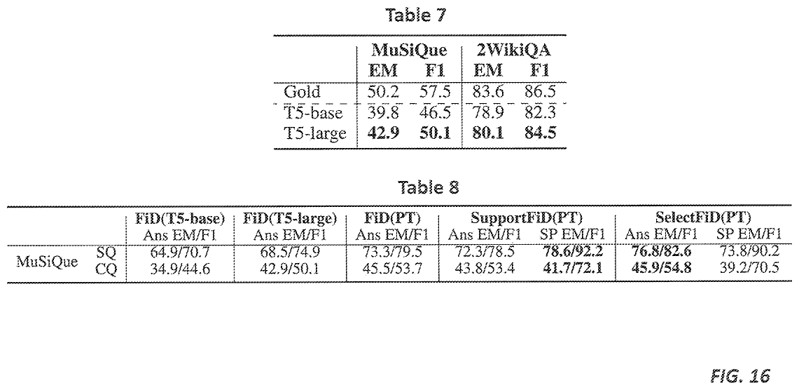

Referring to FIGS. 10-18, exemplary experiments results using various embodiments described herein are illustrated. Examples of FIGS. 10, 11, 12, 13, and 14 illustrate the conversion of original data in the datasets into the training format for both question parsing and execution. Tables 3-6 of FIG. 15 illustrate experiment results under the supervised setting, few-shot setting, and zero-shot setting. For the supervised setting, the experiments are conducted on two multi-hop multi-passage textual QA datasets, MuSiQue and 2Wikimulti-hopQA, which contain complex questions and corresponding decomposed simple questions (see, e.g., Table 3 of FIG. 15). Under the few shot setting, the HPE framework's generalization is tested using 5-20% of the training data (see, e.g., Table 4 of FIG. 15). Under the zero-shot setting, the HPE framework is tested on both complex (HotpotQA) and simple (NQ) QA datasets (see, e.g., Tables 5 and 6 of FIG. 15). The zero-shot setting is closer to real scenarios, where neither decomposed questions nor the complexity of questions is known. Ablation study is carried out to analyze the impact of H-Parser and the impact of the H-Executor (see, e.g., Tables 7 and 8 of FIG. 16). A case study is carried out to demonstrate the interpretability of the HPE framework.

The experiments use the MuSiQue and 2WikiQA datasets. Each of the MuSiQue and 2WikiQA datasets is first described below, followed by explanation on how to convert original data into the training format for both question parsing and execution. MuSiQue (Trivedi et al., 2022b, Musique: Multi-hop questions via single-hop question composition, Transactions of the Association for Computational Linguistics, 10:539-554) dataset contains multi-hop reasoning questions with the mixed number of hops and question entities which can be asked from 20 supporting passages. It contains 19,938/2,417/2,459 samples for train, dev and test sets respectively, with 2hop1 (questions with 2 hops and 1 entity), 3hop1, 4hop1, 3hop2, 4hop2 and 4hop3 reasoning types.

2Wikimulti-hopQA (2WikiQA) (Ho et al., 2020, Constructing a multi-hop qa dataset for comprehensive evaluation of reasoning steps, arXiv preprint arXiv:2011.01060) dataset requires models to read and perform multi-hop reasoning over 10 multiple passages. Three types of reasoning are included, namely comparison, bridge, and bridge-comparison. It contains 167,454/12,576/12,576 samples for train, dev and test sets respectively.

Reconstruction is performed to convert each dataset into the training format for both question parsing and execution. Table 2 of FIG. 10 illustrates examples of question and corresponding H-expression under three basic reasoning types “Bridge,” “Intersection,” and “Comparison.”

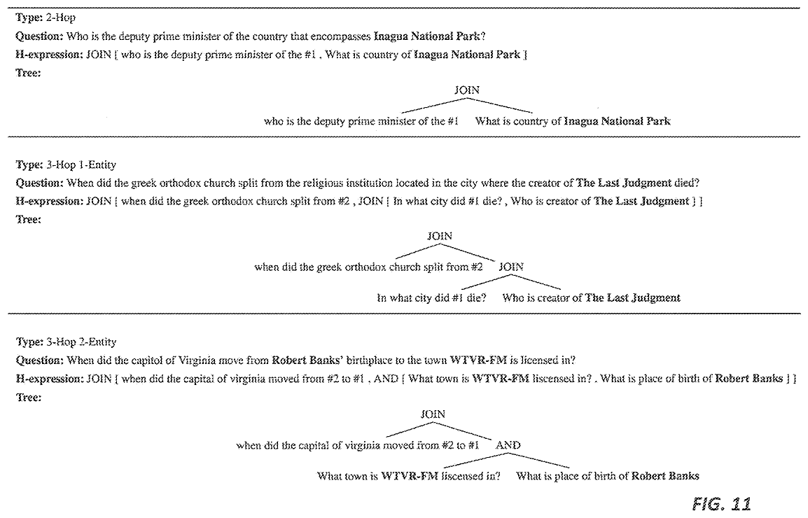

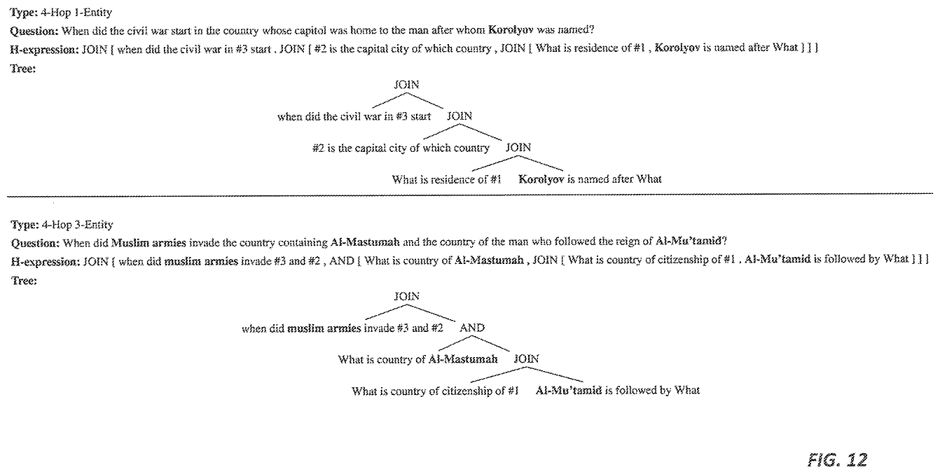

Referring to the examples of FIGS. 11 and 12, illustrated are example training sets converted from MuSiQue dataset, where MuSiQue contains complex questions, decomposed single question with answers, and the reasoning type for each complex question. The JOIN operation is used to combine linearly-chain type questions together, and the AND operation is used to combine intersection type questions.

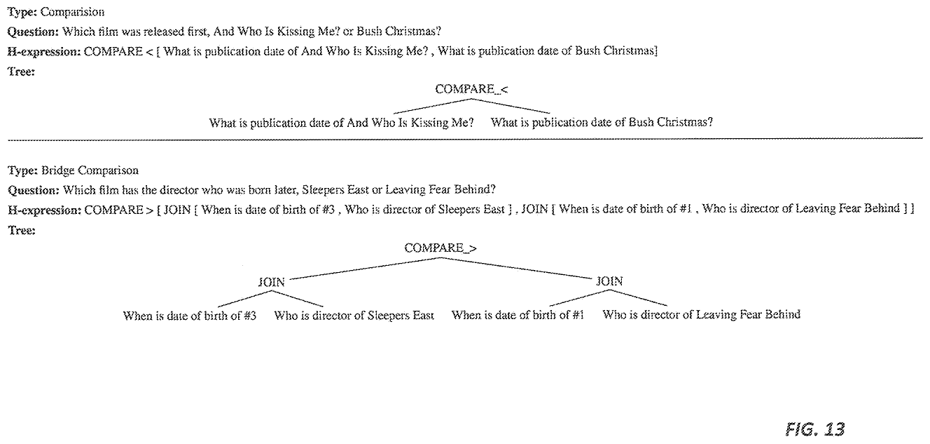

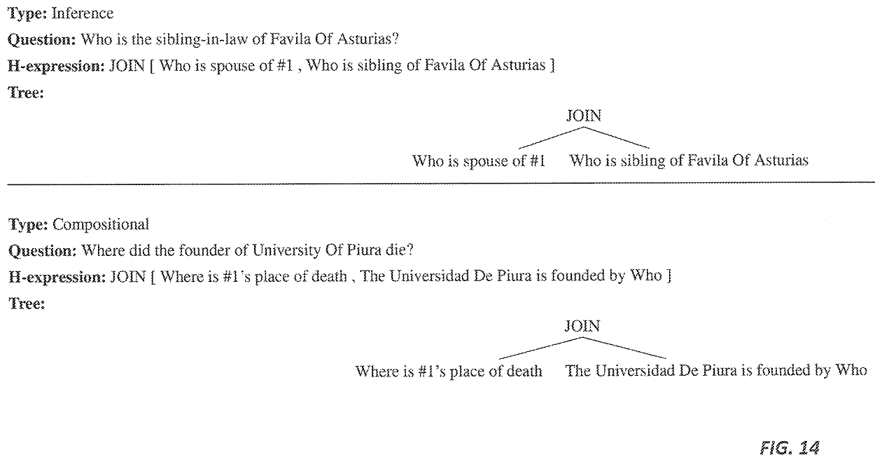

Referring to the examples of FIGS. 13 and 14, illustrated are example training sets converted from 2WikiQA. In 2WikiQA, evidences (e.g., in the form of triplet <subject, relation, object>) and reasoning type are used to create the H-Expression. Specifically, the subject and relation of 2WikiQA are first converted into natural questions using templates, and the object of 2WikiQA is the answer of this natural question. Then, operations are used to combine those single-hop questions into an H-Expression based on their reasoning type. FIGS. 14 and 15 include examples of complex questions and corresponding H-Expressions, with reasoning types of “Comparison,” “Bridge Comparison,” “Inference,” and “Compositional.”

### Experiments under Supervised Setting

Referring to the examples of Table 3 of FIG. 15, evaluation metrics for the experiments of the supervised setting are described. Official evaluation scripts are used for each dataset with two metrics to measure answer exact match accuracy (EM) and answer token-level accuracy (F1). The large language model baselines (“Large LM”) include Self-ask +Search (Press et al. (2022)) and IRCoT (Trivedi et al. (2022a)), which make use of large language models like GPT-3 (Brown et al., 2020). These baseline models iteratively generate an answerable question, use retrieval to get supporting passages, and answer the question based on the retrieved passages.

As shown in Table 3 of FIG. 15, the state of the art (SOTA) baseline models include SA (Trivedi et al., 2022b), EX(SA) (Trivedi et al., 2022b), and NA-Reviewer (Fu et al., 2022). SA is the state-of-the-art model on the MuSiQue dataset, which first uses a RoBERTa based (Liu et al., 2019) ranking model to rank supporting passages and then uses an End2End reader model to answer complex questions using the top-k ranked passages. EX(SA) model (Trivedi et al., 2022b) decomposes a complex question into single-hop questions and builds a directed acyclic graph (DAG) for each single-hop reader (SA) to memorize the answer flow. NA-Reviewer model (Fu et al., 2022) proposes a reviewer model that can fix the error prediction from incorrect evidence.

The baseline End2End reader models include the original FiD (Izacard and Grave, 2020) and variants of the original FiD. The original FiD takes the input question as well as the supporting passages as input, and generates the answer as a sequence of tokens. Moreover, variants of FiD are used to compare the influence using H-Expression: for example, FiD_{LF->Ans} uses H-Expressions as the input, instead of original questions, to generate answers (referred to as FiD_{LF->Ans}), and FiD_{CQ->LF+Ans} uses questions as input to generate both H-Expressions and answers (referred to as FiD_{CQ->LF+Ans}). PT represents pretraining on the reader network.

As described in detail below, the question parsing model and the single-hop reader models of the HPE framework are pretrained, and in some embodiments further fined-tuned, for performing the question answering tasks.

During the pretrain process, to pretrain the single-hop reader based on a T5-large model, a subset of PAQ (Lewis et al., 2021) consisting of 20M pairs is used. This subset is generated based on named entities and the greedy decoded top-1 sequence with the beam size of 4. The T5-large model is trained for 400 k steps, with one gold passage, maximum length of 256 and batch size of 64. Then FiD is initialized with the PAQ pre-trained model, and further trained for 40 k steps, with batch size of 8 and 20 supporting passages, on the combined training sets of TriviaQA (Joshi et al., 2017), SQuAD (Rajpurkar et al., 2016) and BoolQ (Clark et al., 2019). All the experiments are conducted on a cloud instance with eight NVIDIA A100 GPUs (40 GB).

In some embodiments, further fine-tuning is performed for question parsing models and/or single-hop reader models. During the fine-tuning process, to train the question parser, the H-Parser is initialized using T5-large model. The H-Parser is then trained with batch size of 32 with a learning rate of 3e-5 for 20 epochs on both MuSiQue and 2WikiQA. The H-Parser model weights are selected based on evaluating the H-Expression exact match.

During the fine-tuning process, the reader network FiD (e.g., based on the T5-large model.) is fine-tuned using 20 passages with a maximum length of 256 tokens used for input blocks on MuSiQue dataset, and 10 passages with 356 tokens used as text length on the 2WikiQA dataset. The reader model is trained with a batch size of 8 with a learning rate of 5e-4 for 40 k steps.

Referring to Table 3 of FIG. 10, the fine-tuning results on MuSiQue and 2WikiQA are presented. It is observed that Self-ask and IRCoT, which are based on large language models and search engines, underperform most supervised models. This indicates that multi-hop multi-paragraph question answering is a difficult task, and there still has an evident gap between supervised small models and large models with few-shot or zero-shot. Moreover, the HPE framework outperforms the SOTA methods on both datasets. It is noticed that the baseline EX(SA) underperforms SA by a large margin, and the HPE framework outperforms FiD by 5.3% on MuSiQue EM. This illustrates the difficulty to build a good H-Expression and executor for the H-Expression. Moreover, it is observed that EX(SA) on 2WikiQA underperforms other models, which shows that using DAG to represent the logical relationship between sub-questions is not adaptable to any reasoning type. Compared with the End2End baseline (FiD) that the HPE framework is built on, the HPE framework (which has an explicit representation) performs much better. Further, as shown in the performance of FiD_{LF->Ans} and FiD_{CQ->LF+Ans}, using H-Expression as the input or output (with the expectation to facilitate the model to capture the decomposition and reasoning path in an implicit way) does not help with the performance. The performance results of FiD_{LF->Ans} and FiD_{CQ->LF+Ans} suggest that among these models, only the H-Execution method in the HPE framework can help the model capture the logical reasoning represented in the H-Expression.

### Experiments Under Few-Shot Setting

Referring to the example Table 4 of FIG. 15, the analysis of the HPE framework under the few-shot setting is provided, which illustrates the generalization ability of the HPE framework. As shown in Table 4, three experiments are performed by randomly sampling 5, 10, and 20 percentage of the training data. The End2End FiD model is used as the baseline, where the inputs are complex questions, and the answers are generated as token sequences. In the experiment with 5% MuSiQue training data, the HPE framework obtains a 4.9% absolute gain on MuSiQue EM score, in comparison to the FiD model. Moreover, in the experiment with 20% MuSiQue training data, the HPE framework achieves 36.4 EM score, which is a comparable performance with FiD trained on full-data (37.6 EM). Similar trends are also observed on 2WikiQA. In summary, the overall experiment under the few-shot setting shows that the HPE framework has better generalization ability than the End2End model. Such generalization improvement is obtained by decomposing complex questions into single-hop ones and representing in H-Expressions.

### Experiments Under Zero-Shot Setting

Referring to experiment results in Table 5 and Table 6 of FIG. 10, experiments under zero-shot setting are performed to verify that the H-Parser works well on questions of varying levels of complexity. Specifically, tests are performed on two benchmarks HotpotQA and NQ without any tuning. HotpotQA does not contain any decomposed questions, and NQ contains common questions in the real world.

For HotpotQA, the distractor setting (Yang et al., 2018) is used, where a model needs to answer each question given 10 passages. To produce correct answer for a question, the dataset requires the model to reason across two passages. Note that two main reasoning types “bridge” and “comparison” in HotpotQA are also included in MuSiQue and 2WikiQA.

NQ (Kwiatkowski et al., 2019) contains open-domain questions collected from Google search queries. While NQ is treated usually as a simple question dataset and previous works usually use End2End multi-passage reader like FiD, certain questions in NQ involve multi-hop reasoning, and the model performance can be improved by decomposing them into single-hop questions.

In various embodiments, to seamlessly generate H-Expressions on unseen questions, a global question parser (also referred to as a global H-Parser). This global question parser can understand the complexity of the question, which means it can decompose a complex question into several simple questions and keep the simple question as is. To provide a global question parser, a pretrained generative model T5 (Raffel et al., 2020) is trained to convert questions to H-Expressions using MuSiQue and 2Wikimulti-hopQA datasets. As the two datasets are not the same size, the complex questions are categorized based on their reasoning type, and the same amount of data is sampled for each category. To endow the model with the ability of understanding question complexity, simple questions in those datasets (the H-Expression of a simple question is itself) are used. Moreover, the composition of complex H-Expressions are decoupled into a few of simple H-Expressions to ensure the coverage of all levels of complexity.

Referring to Table 5 of FIG. 15, the experiment results under zero-shot setting on HotpotQA are illustrated. In the experiments, FiD pre-trained on PAQ and TriviaQA, SQuAD and BoolQ is used as the zero-shot reader in the H-Executor. The HPE framework outperforms both Standard and CoT, which use prompt-based large language models. The experiment results illustrate that with the hybrid question parsing and execution in the HPE framework, a small language model may be generalizable on unseen questions. Compared with FiD (PT), the HPE framework achives a comparable performance. The union of HPE and FiD, which takes the correct predictions from both methods, obtains a 15% absolute gain. This shows that HPE correctly answers around 15% of questions that FiD predicts incorrectly, with the help of the question decomposition and symbolic operation.

Referring to Table 6 of FIG. 15, the experiment results under zero-shot setting on NQ are illustrated. The global question parser is used to decompose NQ question in a zero-shot manner. If a question is recognized as single-hop reasoning and cannot be further decomposed, the parser will keep the question unchanged. The DPR model (Karpukhin et al., 2020) is used to retrieve the Top-20 documents from Wikipedia as the supporting documents. Among the 8 k dev set examples, 32 questions have been decomposed into single-hop questions with the logical operations and the rest are left as is. For example, a question “when did the last survivor of the titanic die” is converted into the H-Expression “JOIN [when did A1 die, who was the last person to survive the titanic]”. The result in Table 6 shows that the HPE framework can handle questions of different complexity levels and do not degenerate on simple questions.

### Ablation Study

Referring to Table 7 of FIG. 16, the ablation study to analyze the impact of H-Parser and impact of H-Executor is described. Specifically, the performance of different H-Parsers is studied. Table 7 illustrates the ablation results illustrating different question parsers and the gold H-Expression impact on answer EM and F1 on MuSiQue and 2WikiQA under the same FiD as the single-hop reader. As shown in the experiment results in Table 7, by using T5-large rather than T5-base, around 2 to 4 percent performance improvement is achieved on both datasets. Compared to the result using gold H-Expression, there is more room for improvement on the MuSiQue dataset.

Referring to Table 8 of FIG. 16, the H-Executor is implemented with a combination of symbolic operations and replaceable reader network model, and the influence of different reader networks to the final performance is studied. Different versions of FiD are used in the study. Table 8 includes EM and F1 scores of Answer and Support Passage on MuSiQue using different reader models. SQ represents simple question and CQ represents complex question. Support-FiD generates both answers and the supporting document titles. SelectFiD is a two-step method that first uses a RoBERTa-based (Liu et al., 2019) ranking model to predict the Top-5 relevant documents and feeds them into FiD to generate the answer. As shown in the results in Table 8, a better single-hop reader (e.g., Support-FiD, Select FiD) produces better performance on MuSiQue. The improvement on single-hop reader translates to a significant performance boost on complex questions.

### Error Analysis and Case Study

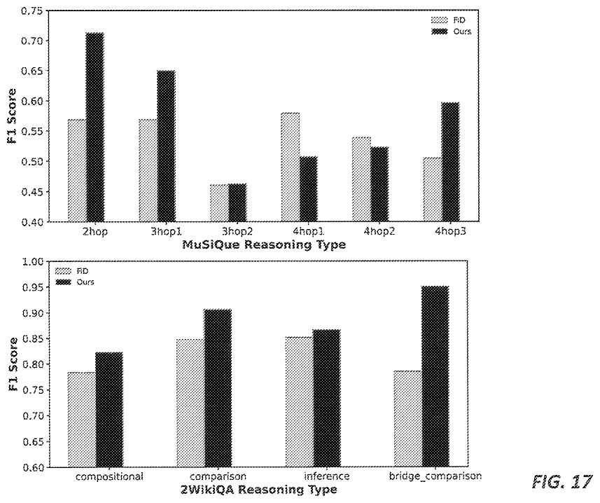

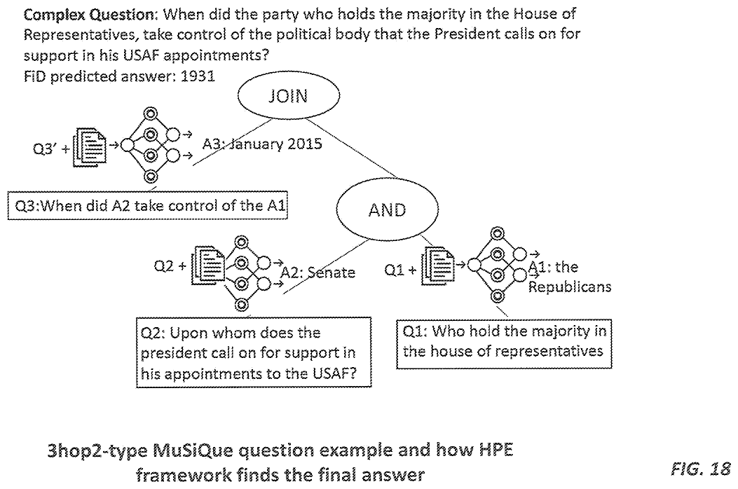

In this section, the error cases are studied. Furthermore, the performance under each reasoning type on MuSiQue and 2WikiQA is illustrated in FIG. 17. An example case of how the HPE framework reasons on a complex question is illustrated in FIG. 18.

There are two types of errors in the prediction results. One is the error from the semantic parsing of the H-Expression. The other is the error from the single-hop question answer by the execution neural network model (e.g., a single-hop reader). The percentage of the first type of error is 67% and the second type is 33% on the MuSiQue dataset.

When the number of hops gets larger, the HPE framework may suffer from exposure bias (Bengio et al., 2015). Due to the chain reasoning, the next step question depends on the previous answers. This problem becomes acute if the HPE framework predicts a bad output at a certain step which in turn affects the final answer. It is noted that one of the advantages of the HPE framework is that once where the error comes from is known, the issue can be corrected to get the correct final answer. To fix a wrong prediction, it may be checked whether the generated H-Expression is correct. If the generated H-Expression is incorrect (e.g., generating a bridge type H-Expression for the comparison type complex question), the H-Expression can be corrected. Otherwise, if it is determined that the error comes from the H-Executor (e.g., the single-hop reader provides an incorrect answer), the incorrect single-hop answer may be corrected. Moreover, in some embodiments, the exposure bias can be solved by using beam search (Wiseman and Rush, 2016), e.g., rather than generating one answer at each step, multiple answers are generated, and the final answer is the highest-scoring one.

Referring to FIG. 17, the experiment results illustrating Answer F1 performance of each different reasoning type on both MuSiQue and 2WikiQA are presented. The HPE framework performs significantly better than directly getting the answer model in both datasets showing that the advantage of delegating semantic parsing to solve complex textual questions. In MuSiQue, for the relevant simpler reasoning types (2hop, 3hop1), the HPE framework outperforms FiD by a great margin. For more complex reasoning types (3hop2, 4hop1, 4hop2 and 4hop3), the HPE framework model gets lower performance compared with the simpler reasoning types, because the exposure bias issue becomes worse with the step of reasoning increase. But it still has an equivalent or better performance compared to End-to-End FiD. In 2WikiQA, the HPE framework performs best on all four reasoning types. Especially on the most complex type of “bridge comparison,” the HPE framework greatly outperform, which shows that using deterministic symbolic representation improves robustness for producing a correct answer.

Referring to FIG. 18, an example case of how the HPE framework reasons on a complex question is illustrated. In the example of FIG. 18, FiD predicts a wrong answer, but the HPE model correctly predicts. As shown in FIG. 18, given a complex question, the HPE framework first parses the complex question into H-expression. Then the H-Executor generates the binary tree from the H-expression. The H-Executor traverses the binary tree from the rightmost left node to the left and upper layer with the consideration of the operation. At each leaf node, the reader neural network may take the sub-question (e.g., single-hop question at the leaf node) and multiple paragraphs as input to generate the sub-answers. The sub-answers may be stored in the memory for later substitution of the placeholder (e.g., A1, A2). For example, Q3 is rewritten by replacing placeholder A1 with the answer of Q1 (the Republicans) and replacing placeholder A2 with the answer of Q2 (Senate) to generate the new question Q3′ “when did Senate take control of the Republicans”. The final answer is obtained by answering Q3′.

As described, various embodiments of the HPE framework may be used to answer complex questions, which combines the strengths of neural network approaches and symbolic approaches. The input question is parsed into H-Expressions, which is executed by H-Executor to get the final answer. The extensive empirical results demonstrate the performance of the HPE framework performance on various datasets under supervised, few-shot, and zero-shot settings. The HPE framework provides strong interpretability by exposing its underlying reasoning process, which facilitates understanding and possibly fixing its errors. Furthermore, the HPE framework may be extended to solve KB and Table QA by replacing the text reader (e.g., single-hop reader) in the H-Executor with KB or Table based neural network models.

While the H-Expression may be defined to cover various reasoning types and different text question answering datasets, in some embodiments, it may not cover some new reasoning types. In those embodiments where there are new reasoning types, the H-Parser may need to be retrained. Alternatively, in some embodiments, in-context learning in a large language model may be used by the H-Parser to generate the H-Expression, such that the H-Parser does not need to be retrained. Furthermore, the H-Executor may be easily adapted to new reasoning types by adding new symbolic rules, and the reader network model doesn't need to be retrained.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of question answering, the method comprising:
receiving, via a data interface, a text document and an input question;
generating, using a hybrid parser model including a first neural network model, a representation of the input question,
wherein the representation includes primitives and operations representing relationships among the primitives;
generating, using a hybrid executor model, an answer to the input question by executing the representation based on the text document, wherein the hybrid executor model includes:
an execution neural network model for executing the primitives of the representation; and
an execution programming model for executing the operations of the representation.

2. The method of claim 1, wherein the input question is a complex question, and
wherein the primitives include single-hop questions.

3. The method of claim 1, wherein the hybrid executor model includes:
an interpreter for generating a tree structure based on the representation;
wherein the hybrid executor model executes the representation by traversing the tree structure.

4. The method of claim 3, wherein the tree structure includes:
a plurality of leaf nodes corresponding to the primitives; and
one or more non-leaf nodes corresponding to the operations.

5. The method of claim 4, wherein the execution neural network model is used to execute the leaf nodes, and wherein the execution programming model is used to execute the non-leaf nodes.

6. The method of claim 1, wherein the execution programming model includes deterministic symbolic rules.

7. The method of claim 1, wherein the execution neural network model includes a knowledge based neural network model, and
wherein the hybrid executor model generates the answer to the input question by executing the representation based on a knowledge base.

8. A system for question answering, the system comprising:
a memory that stores a hybrid question parser and executor model and a plurality of processor-executable instructions,
wherein the hybrid question parser and executor model includes a hybrid parser model and a hybrid executor model;
a communication interface that receives a text document and an input question; and
one or more hardware processors that read and execute the plurality of processor-executable instructions from the memory to perform operations comprising:
generating, using the hybrid parser model including a first neural network model, a representation of the input question,
wherein the representation includes primitives and operations representing relationships among the primitives;
generating, using the hybrid executor model, an answer to the input question by executing the representation based on the text document, wherein the hybrid executor model includes:
an execution neural network model for executing the primitives of the representation; and
an execution programming model for executing the operations of the representation.

9. The system of claim 8, wherein the input question is a complex question, and
wherein the primitives include single-hop questions.

10. The system of claim 8, wherein the hybrid executor model includes:
an interpreter for generating a tree structure based on the representation;
wherein the hybrid executor model executes the representation by traversing the tree structure.

11. The system of claim 10, wherein the tree structure includes:
a plurality of leaf nodes corresponding to the primitives; and
one or more non-leaf nodes corresponding to the operations.

12. The system of claim 11, wherein the execution neural network model is used to execute the leaf nodes, and wherein the execution programming model is used to execute the non-leaf nodes.

13. The system of claim 8, wherein the execution programming model includes deterministic symbolic rules.

14. The system of claim 8, wherein the execution neural network model includes a knowledge based neural network model, and
wherein the hybrid executor model generates the answer to the input question by executing the representation based on a knowledge base.

15. A non-transitory machine-readable medium comprising a plurality of machine-executable instructions which, when executed by one or more processors, are adapted to cause the one or more processors to perform operations comprising:
receiving, via a data interface, a text document and an input question;
generating, using a hybrid parser model including a first neural network model, a representation of the input question,
wherein the representation includes primitives and operations representing relationships among the primitives;
generating, using a hybrid executor model, an answer to the input question by executing the representation based on the text document, wherein the hybrid executor model includes:
an execution neural network model for executing the primitives of the representation; and
an execution programming model for executing the operations of the representation.

16. The non-transitory machine-readable medium of claim 15, wherein the input question is a complex question, and wherein the primitives include single-hop questions.

17. The non-transitory machine-readable medium of claim 15, wherein the hybrid executor model includes:
an interpreter for generating a tree structure based on the representation;
wherein the hybrid executor model executes the representation by traversing the tree structure.

18. The non-transitory machine-readable medium of claim 17, wherein the tree structure includes:
a plurality of leaf nodes corresponding to the primitives; and
one or more non-leaf nodes corresponding to the operations.

19. The non-transitory machine-readable medium of claim 18, wherein the execution neural network model is used to execute the leaf nodes, and wherein the execution programming model is used to execute the non-leaf nodes.

20. The non-transitory machine-readable medium of claim 15, wherein the execution programming model includes deterministic symbolic rules.
